(19) United States
(12) Patent Application Publication
(10) Pub. No.: US 2017/0161414 A1
(43) Pub. Date: Jun. 8, 2017

(54) METHOD FOR VALIDATING A DRIVER ASSISTANCE FUNCTION OF A MOTOR VEHICLE

(71) Applicant: Robert Bosch GmbH, Stuttgart (DE)

(72) Inventors: Frank Kible, Steinheim A. D. Murr (DE); Simon Hauber, Freiberg Am Neckar (DE)

(21) Appl. No.: 15/366,457

(22) Filed: Dec. 1, 2016

(30) Foreign Application Priority Data
Dec. 8, 2015 (DE) 102015224558.6

(51) Int. Cl. G06F 17/50; B60W 50/04

(52) U.S. Cl. CPC G06F 17/5009; B60W 50/045; G06F 17/5095; B60W 2540/00

(57) ABSTRACT

A method for validating a driver assistance function of a motor vehicle, including operating an automated vehicle object in an electronic simulation environment using a vehicle model and the driver assistance function, the automated vehicle object being operated in the simulation environment together with at least one other vehicle object, the at least one other vehicle object being controlled by a human being, and evaluating the driver assistance function as a function of the behavior of the automated vehicle object in reaction to the behavior of the at least one other vehicle object.

### CROSS REFERENCE

The present application claims the benefit under 35 U.S.C. §119 of German Patent Application No. DE 102015224558.6 filed on Dec. 8, 2015, which is expressly incorporated herein by reference in its entirety.

### FIELD

The present invention relates to a method for validating a driver assistance function of a motor vehicle. The present invention additionally relates to a device for validating a driver assistance function of a motor vehicle.

### BACKGROUND INFORMATION

Concepts for automated driving operation for motor vehicles are available in the related art. Conventional systems, such as adaptive cruise control, lane assist systems, blind spot assist systems, automatic emergency braking systems, parking assistance systems, traffic jam assist systems, etc. are systems for implementing a partially autonomous driving operation using longitudinal control, transverse control, etc. of the motor vehicle. Speed limiters are additionally conventional, with which it is possible for the longitudinal control to set maximum speeds so that the motor vehicle may not be accelerated to higher speeds.

During automated driving, the motor vehicle should be free of human support, perceive the surroundings exclusively with the aid of sensors, and bring the driver safely and without accident to his/her destination. Different sensors are used for the purpose of detecting the surroundings of the motor vehicle.

Conventional technologies are additionally available which monitor and detect a physical or physiological state of the driver of the motor vehicle. It may thereby be provided to identify a driver, detect his/her level of attention, detect a state of health and his/her intentions, etc.

Previous developments have been carried out corresponding to the so-called V-model: the worst cases are derived from a technical specification which contains applications. However, it is not possible to use the V-Model to generate a detailed specification of this type which would be able to cover all possible situations in traffic.

### SUMMARY

One object of the present invention is to provide an improved method for validating a driver assistance function of a motor vehicle.

The object may be achieved according to a first aspect with a method for validating a driver assistance function of a motor vehicle, including the steps:
operating an automated vehicle object using a vehicle model and the vehicle assistance function in an electronic simulation environment;
the vehicle object being operated in the simulation environment together with at least one other vehicle object, the at least one other vehicle object being controlled by a human being; and
evaluating the driver assistance function as a function of the behavior of the automated vehicle object in reaction to the behavior of the at least one other vehicle object.

According to a second aspect, the object is achieved by a device for validating a driver assistance function of a motor vehicle including:
an electronic simulation environment;
an automated vehicle object with a vehicle model including the driver assistance function, the automated vehicle object being operable in the simulation environment;
at least one other vehicle object, which is controllable by a human being, being operable in the simulation environment; and
a monitoring unit with the aid of which a behavior of the driver assistance function is monitorable in the simulation environment.

In this way, a validation of the driver assistance function may be carried out in numerous simulation scenarios, a human factor being introduced advantageously in this way into the validation of the driver assistance function. In this type of simulation environment, particularly extreme situations for the driver assistance function may be advantageously provided because experience suggests that players behave more extremely in this type of environment than in actual traffic. A functionality of the driver assistance function may be improved in a targeted manner and optimized with the aid of the thus achievable gain of knowledge. By using a representative group of testing individuals, comprehensive data may correspondingly be provided for the validation of the driver assistance function.

Advantageous refinements of the method and the device are described herein.

One advantageous refinement of the method provides that the scenarios of the operation of the automated vehicle object are logged. In this way it is possible to obtain extensive data material for validation data which may be used for optimizing the driver assistance function.

Another advantageous refinement of the method provides that the vehicle model includes at least one of the following: a dynamic model of the motor vehicle, a hydraulic model of the motor vehicle, a surroundings model. In this way, a reproduction preferably true to detail of the motor vehicle and the surroundings may be carried out so that the driver assistance function “does not recognize” that it is involved in a hands-on simulation operation.

Another advantageous refinement of the method provides that a behavior of the at least one additional vehicle object in the simulation environment is converted via a sensor unit into sensor inputs for the vehicle model. In this way, a preferably realistic behavior of other road users may be simulated for the automated vehicle object.

Another advantageous refinement of the method is characterized in that an interaction of the automated vehicle object with the simulation environment is carried out via an interaction unit. In this way, an interface together with the sensor unit may be provided as an interface of the automated vehicle object with the environment. In this case, the control signals from the simulation environment and also the control signals to the actuators are processed in such a way that the vehicle model does not recognize that it is involved in a simulation operation.

Another advantageous refinement of the method provides that a behavior of the automated vehicle object is monitored with the aid of a monitoring unit. In this way, validation data may advantageously be provided. It may be advantageously detectable in this way, whether the driver assistance function corresponds to predefined specifications by detecting how many kilometers and under what circumstances the vehicle assistance function has been operated.

Another advantageous refinement of the method provides that validation data are entered into a database which is used for interpreting the driver assistance function. In this way, a verification and validation database is provided, with the aid of which a gain of knowledge in the simulation operation is converted into features of the driver assistance function for actual operation.

Another advantageous refinement of the method provides that multiple automated vehicle objects are operated in the simulation environment. In this way, a test of a behavior by multiple algorithms is advantageously supported with respect to one another.

The present invention will be subsequently described in greater detail with additional features and advantages by way of two figures. All described or depicted features, alone or in any combination, form the subject matter of the present invention, regardless of their recapitulation in the patent claims or their back reference, and regardless of their wording or depiction in the description or in the figures. The figures are primarily provided to clarify certain basic principles of the present invention.

### BRIEF DESCRIPTION OF THE DRAWINGS

FIG. 1 shows a schematic block diagram of a specific embodiment of the device according to the present invention.

FIG. 2 shows a schematic progression of a specific embodiment of the method according to the present invention.

### DETAILED DESCRIPTION OF EXAMPLE EMBODIMENTS

Subsequently, the term “validation” will be understood as a verification process, with which it is to be ensured that a product has the intended features.

From the above-mentioned disadvantages, it is not possible to use the V-model for comprehensive evaluation of driver assistance functions, because the technical options are insufficient. If the automated driving is to be safeguarded exclusively via road tests, then road kilometers driven in the amount of approximately 100 million km are required. This is based on the statistically based assumption that one fatal accident occurs per 100 million kilometers driven.

Another option for validating a driver assistance function involves the method of the so-called “vehicle model in the loop.” This is understood to mean that the motor vehicle, including all of its automated assistance systems (the product to be validated), is generated as a software model, including the sensors and actuators, which are operated in a software environmental model.

Approximately since the start of the 21^{st} century, the so-called “massively multiplayer online games” have been available. In these games, an open world is often simulated for the players, which are accessible via the Internet and are configured very much true to detail. Vehicle and aircraft games of all types are included among the simulation games, for example, automobile and motorcycle racing simulations. The maps contained and present in these simulations are often inspired by actual racetracks or road courses and map the environmental situation (gaming engine) in the games quite realistically (visually, physically, surroundings and environmental behavior, etc.).

According to the present invention, a method for validating a driver assistance system in this type of surroundings is described, which has the advantage that other road users do not have to be modeled. The driver model is namely substituted by an actual driver, which corresponds to the principle of gamification.

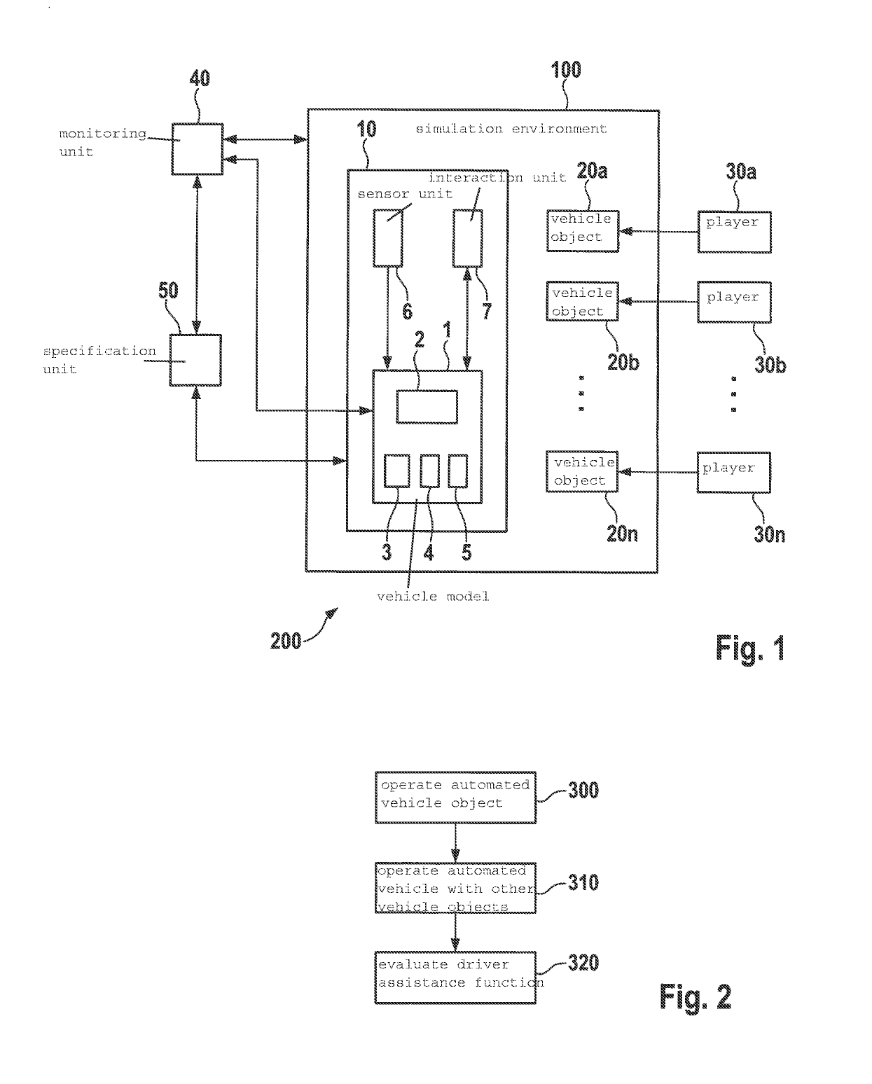

FIG. 1 shows a schematic block diagram of a device 200 for evaluating a driver assistance function 2 of a motor vehicle in an above-mentioned simulation environment.

A surroundings model, implemented using software technology, in the form of a simulation environment 100 is provided for this purpose, in which different vehicle objects 20a . . . 20n operate in a simulation operation. Simulation environment 100 may sufficiently exactly simulate physical conditions of the actual world, a road section also being included for this purpose. One of vehicle objects 20a . . . 20n is manually operated or controlled by players 30a . . . 30n.

In addition to vehicle objects 20a . . . 20n in simulation environment 100, an automated vehicle object 10 is also used, which includes a vehicle model 1 with a driver assistance function 2 to be validated.

Automated vehicle object 10 is not visible in the simulation environment 100 to persons 30a . . . 30n as an autonomous vehicle model. In the simulation, vehicle object 10 moves as if it were controlled by a player. In order to achieve this goal, automated vehicle object 10 includes a sensor unit 6 which generates the positions of automated vehicle object 10 in simulation environment 100 in sensor values that are understandable for automated vehicle object 10.

Furthermore, vehicle model 1 includes for this purpose an interaction unit 7, which, together with sensor unit 6, represents an interface of automated vehicle object 10 with the simulated surroundings situation of simulation environment 100 via the vehicle actuators (e.g., brakes, engine torque, etc.). Data from simulation environment 100 and also control signals to the actuators are processed here in such a way that it is not obvious to vehicle model 1 that it is involved in a simulation operation.

Vehicle model 1 is the same as is used in an actual automated or autonomous motor vehicle. It includes all components necessary for this purpose, such as driver assistance system 2, a hydraulic model 4, a dynamic model 3, and a surroundings model 5. The composition of vehicle model 1 is, however, irrelevant to the method for validation; it might just as well be represented as a black box.

A specification unit 50 represents a driver's intention, target specifications, e.g. how and where to drive being specified with the aid of specification unit 50 of automated vehicle object 10. Target specifications may, in this context, be, for example the following parameters:
distance, destination;
efficiency, consumption, economy, ecology of the motor vehicle operation; aggressiveness, interaction with other motor vehicles;
safety specifications for collision prevention in order to not impede or endanger other road users.

Furthermore, a monitoring unit 40 is provided which records a progression of the simulation activity and checks for compliance with safety specifications. For this purpose, monitoring unit 40 has interfaces to autonomous vehicle model 1 to be validated and also to simulation environment 100, where the interactions of the different vehicles are recorded and evaluated.

Players 30a . . . 30n control their vehicle objects 20a . . . 20n (avatars) via conventional interfaces with the aid of a controller, e.g., with the aid of a game pad, a steering wheel, a touch pad, with the aid of optical identifiers, etc., with the aid of a browser application or with the aid of a locally-installed software application.

The entire simulation action is preferably logged, the results then flowing into a database (not shown), with the aid of these data, an improvement or optimization of driver assistance function 2 is then carried out.

FIG. 2 shows a schematic progression of the method according to the present invention:

In a step 300, an operation of automated vehicle object 10 is carried out in an electronic simulation environment using a vehicle model and the driver assistance function.

In a step 310, automated vehicle object 10 is operated in simulation environment 100 together with at least one other vehicle object 20a . . . 20n, the at least one other vehicle object 20a . . . 20n being controlled by a human being.

In a step 320, an evaluation of driver assistance function 2 is carried out as a function of the behavior of the automated vehicle object in reaction to the behavior of the at least one other vehicle object.

In summary, the present invention provides a method and a device for validating or verifying a driver assistance function of a motor vehicle, with which non-functional evaluation criteria for the driver assistance function may be used in an advantageous manner. Due to a large number of validation participants playing in a simulated environment, comprehensive data material may be generated which may significantly shorten a time to market of a sufficiently tested driver assistance function.

Those skilled in the art may modify and/or combine the features of the present invention with one another in a suitable manner without deviating from the core of the present invention.

What is claimed is:

1. A method for validating a driver assistance function of a motor vehicle, comprising:
operating an automated vehicle object in an electronic simulation environment using a vehicle model and the driver assistance function, the automated vehicle object being operated in the simulation environment together with at least one other vehicle object, the at least one other vehicle object being controlled by a human being; and
evaluating the driver assistance function as a function of behavior of the automated vehicle object in reaction to behavior of the at least one other vehicle object in the simulation environment.

2. The method as recited in claim 1, wherein scenarios of operating the automated vehicle object are logged.

3. The method as recited in claim 1, wherein the vehicle model includes at least one of the following: a dynamic model of the motor vehicle, a hydraulic model of the motor vehicle, a surroundings model.

4. The method as recited in claim 1, wherein a behavior of the at least one other vehicle object in the simulation environment is converted into sensor inputs for the vehicle model via a sensor unit.

5. The method as recited in claim 1, wherein an interaction of the automated vehicle object with the simulation environment is carried out via an interaction unit.

6. The method as recited in claim 1, wherein a behavior of the automated vehicle object is monitored with the aid of a monitoring unit.

7. The method as recited in claim 6, wherein validation data are entered into a database which is used for designing the driver assistance function.

8. The method as recited in claim 1, wherein multiple automated vehicle objects are operated in the simulation environment.

9. A device for validating a driver assistance function of a motor vehicle in an electronic simulation environment, the device comprising:
an automated vehicle object with a vehicle model including the driver assistance function, the automated vehicle object being operable in the simulation environment;
at least one other vehicle object which is controllable by a human being, operable in the simulation environment; and
a monitoring unit with the aid of which a behavior of the driver assistance function is monitorable in the simulation environment.

10. The device as recited in claim 9, further comprising:
a specification unit with the aid of which parameters are specifiable for the simulation environment and for the automated vehicle object.

11. A non-transitory computer-readable storage medium on which is stored a computer program for validating a driver assistance function of a motor vehicle, the computer program, when executed by a processor, causing the processor to perform:
operating an automated vehicle object in an electronic simulation environment using a vehicle model and the driver assistance function, the automated vehicle object being operated in the simulation environment together with at least one other vehicle object, the at least one other vehicle object being controlled by a human being; and
evaluating the driver assistance function as a function of behavior of the automated vehicle object in reaction to behavior of the at least one other vehicle object in the simulation environment.
